(19) United States
(12) Patent Application Publication
(10) Pub. No.: US 2008/0222098 A1
(43) Pub. Date: Sep. 11, 2008

(54) METHODS, SYSTEMS, AND COMPUTER PROGRAM PRODUCTS FOR PROVIDING CONSOLIDATED ORDER INFORMATION

(75) Inventor: Joseph Simpson, Stone Mountain, GA (US)

Correspondence Address: CANTOR COLBURN LLP - BELLSOUTH, 20 Church Street, 22nd Floor, Hartford, CT, 06103, US

(73) Assignee: BELLSOUTH INTELLECTUAL PROPERTY CORPORATION, Wilmington, DE (US)

(21) Appl. No.: 11/682,411

(22) Filed: Mar. 6, 2007

(51) Int. Cl. G06F 17/30

(52) U.S. Cl. 707/3

(57) ABSTRACT

Exemplary embodiments relate to methods, systems, and computer program products for providing consolidated order information. Methods include receiving one or more order numbers corresponding to customer orders for network provider services. Information corresponding to the orders numbers are retrieved from a plurality of sources including order summary data, order detail data, customer data and network data. The retrieved information is stored as consolidated order data. A request for a report is received from a user. The request includes selection criteria specifying a subset of the consolidated order data. The report is created by applying the selection criteria to the consolidated order data and the report is transmitted to the user.

### BACKGROUND

Exemplary embodiments relate generally to providing order information, and more particularly, to methods, systems and computer program products for providing consolidated order information for network provider services.

Today, determining information about an order for a network provider service has been automated in some respects. Network providers typically utilize one or more software applications to provide order summary and order detail information. In addition, other software applications provide information about the customer placing the order. Further additional software applications provide information about the network/hardware environment utilized to support the network provider services that are currently utilized at the customer location and/or required to be installed at the customer location to complete the order. To gather information about an order (including order details, customer information and network information) employees of the network provider are required to review two or more sources of data and/or to manually enter the data for consolidation into a single database. Generating summary information for a business unit such as what orders are complete, who completed the order, the quality level associated with completing the order and a comparison to other business units typically requires a review of two or more sources of data. It would be desirable to have an automated system to collect data generated by a variety of software application systems to provide a consolidated order database including order details, customer information and network information. In addition, it would be desirable to be able to tailor reports containing order information to individual business units.

### SUMMARY

Exemplary embodiments relate to methods, systems and computer program products for providing consolidated order information. Methods include receiving one or more order numbers corresponding to customer orders for network provider services. Information corresponding to the orders numbers are retrieved from a plurality of sources including order summary data, order detail data, customer data and network data. The retrieved information is stored as consolidated order data. A request for a report is received from a user. The request includes selection criteria specifying a subset of the consolidated order data. The report is created by applying the selection criteria to the consolidated order data and the report is transmitted to the user.

Systems for providing consolidated order information include a processor and software instructions executing on the processor. The software instructions facilitate receiving one or more order numbers corresponding to customer orders for network provider services. Information corresponding to the orders numbers are retrieved from a plurality of sources including order summary data, order detail data, customer data and network data. The retrieved information is stored as consolidated order data. A request for a report is received from a user. The request includes selection criteria specifying a subset of the consolidated order data. The report is created by applying the selection criteria to the consolidated order data and the report is transmitted to the user via a network.

Computer program products for providing consolidated order information include a storage medium readable by a processing circuit and storing instructions for execution by the processing circuit for facilitating a method. The method includes receiving one or more order numbers corresponding to customer orders for network provider services. Information corresponding to the orders numbers are retrieved from a plurality of sources including order summary data, order detail data, customer data and network data. The retrieved information is stored as consolidated order data. A request for a report is received from a user. The request includes selection criteria specifying a subset of the consolidated order data. The report is created by applying the selection criteria to the consolidated order data and the report is transmitted to the user.

Other systems, methods, and/or computer program products according to exemplary embodiments will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE DRAWINGS

Referring now to the drawings wherein like elements are numbered alike in the several FIGURES:

FIG. 1 is a block diagram of an exemplary system that may be utilized to provide consolidated order information;

FIG. 2 is a flow diagram of an exemplary process for providing consolidated order information;

FIG. 3 depicts exemplary attributes for consolidated order information data sources; and

FIG. 4 depicts an exemplary order summary report that may be generated from consolidated order information.

### DETAILED DESCRIPTION OF EXEMPLARY EMBODIMENTS

Exemplary embodiments are directed to providing information about customer orders for network provider services. The order information is collected from several sources including order summary data, order detail data, customer data and network data. The collected information is utilized to determine how many orders are in the system, what orders are complete, who completed the orders, percentage of error (quality), and how various business units compare to each other. In addition, the collected information allows business unit managers to see what orders are in the business unit, to transfer manpower to completing the orders, and to determine the manpower required for the entire business and/or for particular business units.

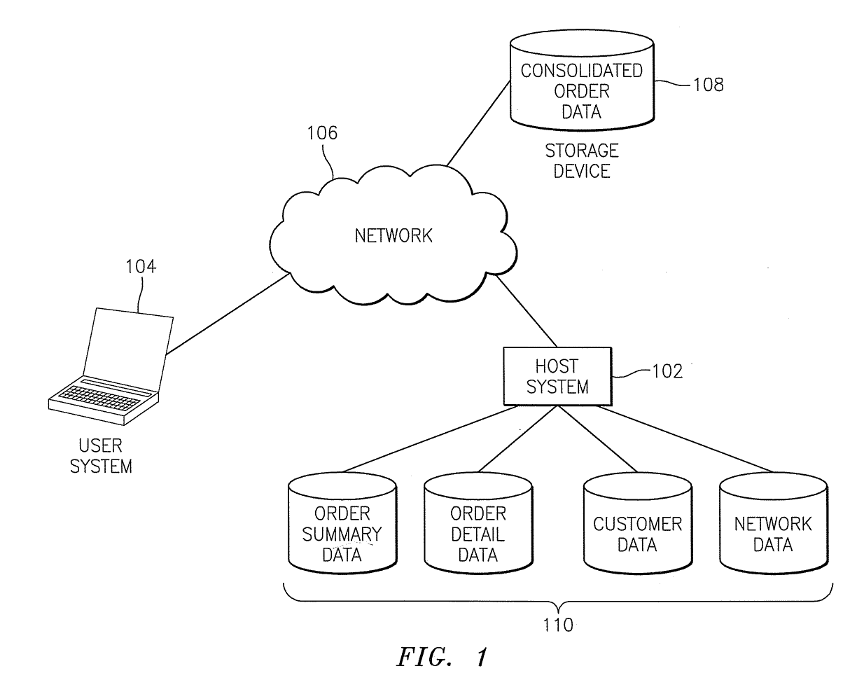

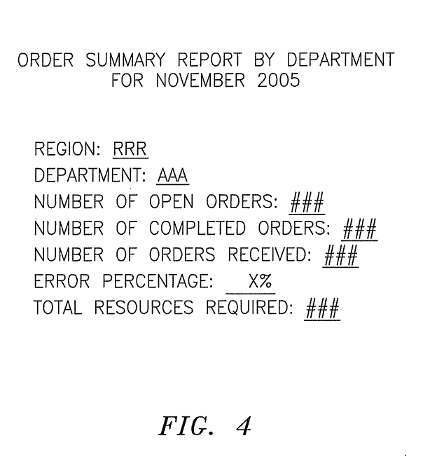

FIG. 1 is a block diagram of an exemplary system that may be utilized to provide consolidated order information. The system depicted in FIG. 1 includes one or more user systems 104, through which users at one or more geographic locations may contact the host system 102 to access the consolidated order information. The user systems 104 may be utilized to request and display reports (such as the one depicted in FIG. 4). The host system 102 executes computer instructions for creating consolidated order data from several sources and for creating reports in response to user requests. The user systems 104 are coupled to the host system 102 via a network 106. Each user system 104 may be implemented using a general-purpose computer executing a computer program for carrying out the processes described herein. The user systems 104 may be implemented by personal computers and/or host attached terminals. If the user systems 104 are personal computers (e.g., laptop, personal digital assistant), the processing described herein may be shared by a user system 104 and the host system 102 (e.g., by providing an applet to the user system).

The consolidated order data sources 110 may include data stores (e.g., databases and data files) created by commercially available order processing software and/or software created specifically for and/or by the network provider. In exemplary embodiments, each of the consolidated order data sources 110 (e.g., the order summary data, the order detail data, the customer data and the network data) are generated by different software systems that may be located in a plurality of geographic locations. In alternate embodiments, two or more of the consolidated order data sources 110 (e.g., the order summary data and the order detail data) are generated by the same software system. Further, each of the consolidated order data sources 110 may be located in the same or different geographic location and may be accessed by the host system 102 via one more or more networks with characteristics similar to the network 106 described herein. In exemplary embodiments, one or more of the consolidated order data sources 110 are accessed by the host system 102 via the same network 106 utilized to provide communication between the host system 102 and the user system 104.

The network 106 may be any type of known network including, but not limited to, a wide area network (WAN), a local area network (LAN), a global network (e.g. Internet, cellular), a virtual private network (VPN), and an intranet. The network 106 may be implemented using a wireless network or any kind of physical network implementation. A user system 104 may be coupled to the host system through multiple networks (e.g., intranet and Internet) so that not all user systems 104 are coupled to the host system 102 through the same network. One or more of the user systems 104 and the host system 102 may be connected to the network 106 in a wireless fashion.

The storage device 108 includes the consolidated order data and any other data relating to providing order information and reports (e.g., report templates). The storage device 108 may be implemented using a variety of devices for storing electronic information. It is understood that the storage device 108 may be implemented using memory contained in the host system 102, a user system 104, or it may be a separate physical device. The storage device 108 is logically addressable as a consolidated data source across a distributed environment that includes a network 106. Information stored in the storage device 108 may be retrieved and manipulated via the host system 102 and/or via one or more user systems 104. In exemplary embodiments, the host system 102 operates as a database server and coordinates access to consolidated order data including data stored on the storage device 108.

The host system 102 depicted in FIG. 1 may be implemented using one or more servers operating in response to a computer program stored in a storage medium accessible by the server. The host system 102 may operate as a network server (e.g., a web server) to communicate with the user systems 104. The host system 102 handles sending and receiving information to and from the user system 104 and can perform associated tasks. The host system 102 may also include a firewall to prevent unauthorized access to the host system 102 and enforce any limitations on authorized access. A firewall may be implemented using conventional hardware and/or software in a manner those skilled in the art would appreciate.

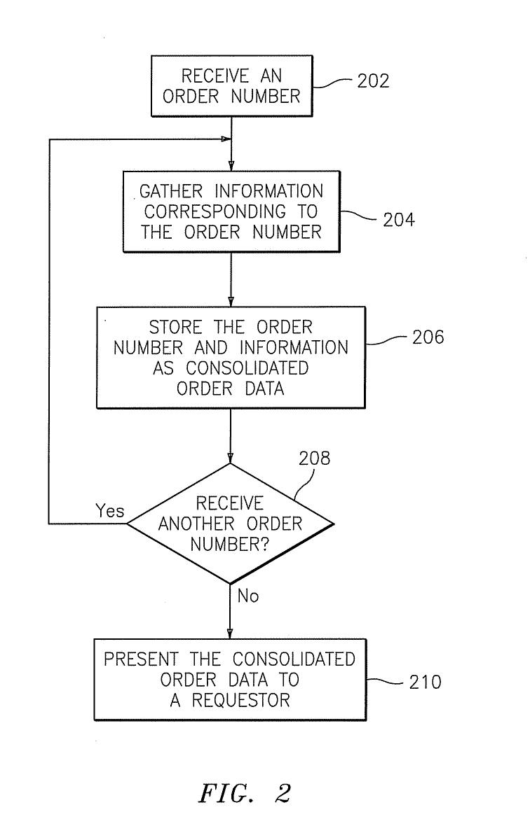

The host system 102 may also operate as an application server. The host system 102 executes one or more computer programs to perform the processing and report generation described herein (see for example, FIGS. 2 and 4). Processing may be shared by the user system 104 and the host system 102 by providing an application (e.g., java applet) to the user system 104.

Alternatively, the user system 104 can include a stand-alone software application for performing a portion or all of the processing described herein. As previously described, it is understood that separate servers may be utilized to implement the network server functions and the application server functions. Alternatively, the network server, the firewall, and the application server may be implemented by a single server executing computer programs to perform the requisite functions.

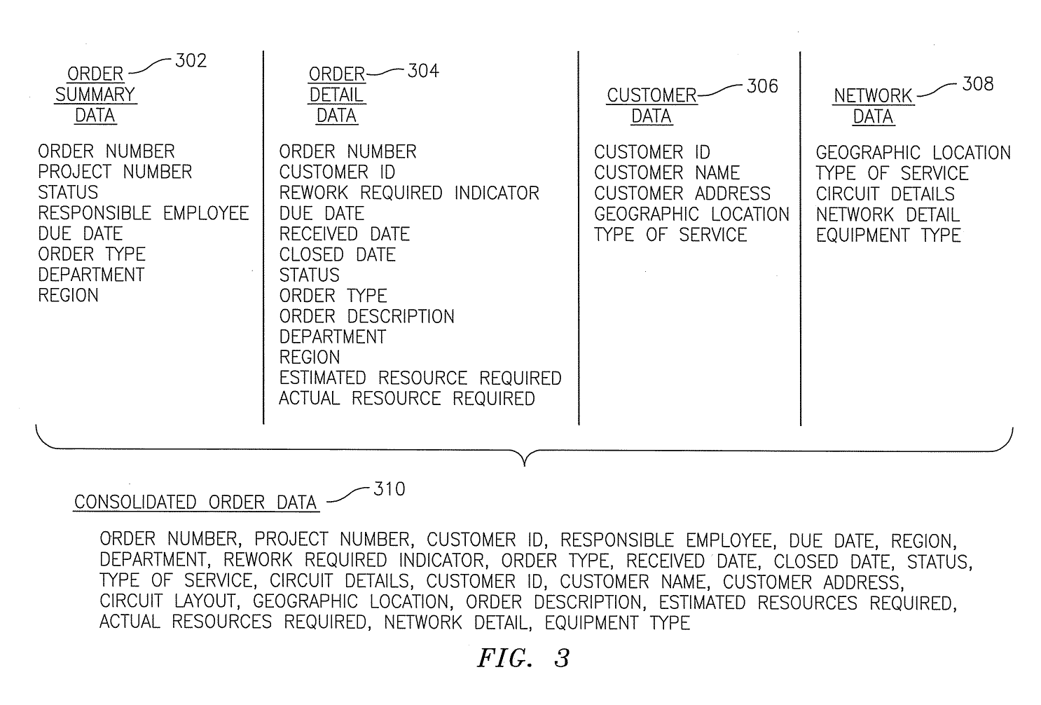

FIG. 2 is a flow diagram of an exemplary process for providing order information. The processing depicted in FIG. 2 may be facilitated by software instructions located on the host system 102. At block 202 an order number corresponding to a customer order for network provider services is received. Network provider services include, but are not limited to Internet access and telephone service. At block 204, information corresponding to the order number is gathered from several consolidated order data sources 110 including, but not limited to order summary data, order detail data, customer data and network data. See FIG. 3 for exemplary attributes that may be included in the consolidated order data sources 110. At block 206, the retrieved information for the order number is stored as the consolidated order data for the order number in the storage device 108. At block 208, a check is made to see if another order number has been received. If another order number has been received, the processing continues at block 204. If another order number has not been received, the processing continues at block 210.

In exemplary embodiments, the order numbers are generated by extracting the order numbers from the order summary data. In this manner, consolidated order data is retrieved for each order that is contained in the order summary data. In alternate exemplary embodiments, the order numbers are generated by selecting a subset of the order numbers in the order summary data, or from another source of order numbers. The order numbers selected may represent a particular business unit such as a department or a region made up of several departments. Alternatively, the order numbers may include only closed orders (e.g., order numbers with a status of closed) to provide historical order information or only open orders (e.g., order numbers with a status of open). The order numbers that are generated are input to the processing depicted in FIG. 2.

At block 210, the consolidated order data is presented to a requestor/user. In exemplary embodiments, the consolidated order data is presented in response to a request received by a user at a user system 104. The request includes selection criteria specifying a subset (or all) of the consolidated order data. A report is created by applying the selection criteria to the consolidated order data. The consolidated order data that matches the selection criteria is utilized to create the report. The selection criteria may limit the number of records and/or the attributes associated with the records that are input to the report. In exemplary embodiments, the report is stored as a database and transmitted to the user. Database query and/or report generation software may be utilized to format the report. Any manner of providing report data may be implemented by exemplary embodiments. For example, the report may be a formatted report that is transmitted to the user. Alternatively, the report may be transmitted to the user in a spreadsheet format.

FIG. 3 depicts exemplary attributes for order information data sources. The attributes depicted in FIG. 3 are intended to be exemplary in nature and other consolidated order data sources and other attributes that are pertinent to order information and order status may be implemented by exemplary embodiments. FIG. 3 depicts example order summary data attributes 302, order detail data attributes 304, customer data attributes 306, and network data attributes 308 that may be stored in the consolidated order data sources 110. In addition, FIG. 3 depicts example attributes for the consolidated order data stored in the storage device 108.

The exemplary order summary data attributes 302 include: order number; project number (e.g., several related orders may make up one project); status (e.g., open and closed); responsible employee; due date; order type (e.g., new service and existing service); department (e.g., a business unit); and region (may be made up of several departments). The data contained in the order summary data may be created and maintained by an order summary application system and/or an ordering application system. The exemplary order detail data attributes 304 depicted in FIG. 3 include: order number (to correlate the data to the order summary data); customer identification (to correlate the data to the customer data); rework required indicator (to track quality); due date; received date; closed date; status; order type; order description; department; region; estimated resource required (type and time); and actual resource required. The data contained in the order detail may be created and maintained by an ordering application system.

The exemplary customer data attributes 306 include: customer identification; customer name; customer address; geographic location (of the services provided to the customer; may be expressed as a global positioning system coordinate); and type of service (e.g., Internet and cellular telephone). The information contained in the customer data may be created and maintained by a customer tracking application system. The exemplary network data attributes 308 include: geographic location (to correlate the data to the customer data); type of service; circuit details (e.g., what currently exists and modifications required to complete the order); network detail (e.g., current set-up and modifications required to complete the order); and equipment type (e.g., signaling system seven “SS7”, and digital subscriber line access multiplexer “DSLAM”). The information contained in the network data may be created and maintained by a network configuration application system.

The exemplary consolidated order data attributes 310 include all of the attributes described with reference to the order summary data attributes 302, the order detail data attributes 304, the customer data attributes 306 and the network data attributes 308. In alternate exemplary embodiments, the consolidated order attributes 310 may include a subset of the attributes in one or more of the order summary data attributes 302, the order detail data attributes 304, the customer data attributes 306 and the network data attributes 308. In addition, the data for each order number may include values in a subset of the consolidated order data attributes 310 because a value may not be found in the consolidate order data sources 110 for every attribute in the consolidated order data.

FIG. 4 depicts an exemplary order summary report that may be created by exemplary embodiments. The report depicted in FIG. 4 summarizes the number of open orders, completed orders, orders received, error percentage for the closed orders and total resources required for the month of November 2005. The report depicted in FIG. 4 may be displayed on the user system 104 and/or printed to paper. The report summarizes information for department “AAA” in region “RRR.” In exemplary embodiments, the selection criteria would specify a department of “AAA” and a due date range of Nov. 1, 2005 to Nov. 30, 2005. The report request would specify that the fields to be displayed include the sums of the fields as depicted in FIG. 1. Any manner of reporting and viewing data may be utilized, for example, in exemplary embodiments the user may be able to select the number of open orders field and be shown detail for each of the orders with a status of open. The detail may include all or a subset of consolidated order data attributes 310.

The report in FIG. 4 is an example of the kind of report that may be generated by exemplary embodiments based on the consolidated order data. Those skilled in the art would recognize that any subset of the consolidated order data attributes 310 and order numbers may be reported as well as a variety of summation data based on the consolidated order data. The display format may be tabular and/or graphical. In addition, templates for reports may be created and stored on the storage device 108.

Reports may be generated from the consolidated order data to allow a department manager to see what orders are currently open in the department and what kinds and numbers of resources (at what locations) are required to fulfill the orders. In exemplary embodiments, the selection criteria would include a due date range, a status of open and a department. The selection criteria could also further limit the consolidated order data attributes 310. These reports allow department mangers to transfer manpower and equipment as needed. In addition, a region manager (where a region includes several department) can use the consolidated order data to plan for an entire region. Other reports may allow a department manager to see orders that were closed during a particular date range and/or orders that were received during a particular date range.

Exemplary embodiments may be utilized to assist in accurately accounting for manpower, time and motion when fulfilling customer orders. Using exemplary embodiments, this is performed by accessing a single system. This may result in providing savings in time spent comparing data from multiple systems and in learning how to utilize multiple systems. In addition, the ability to have access to the consolidated order data for a region may prevent duplication of work between departments.

As described above, embodiments may be in the form of computer-implemented processes and apparatuses for practicing those processes. In exemplary embodiments, the invention is embodied in computer program code executed by one or more network elements. Embodiments include computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. Embodiments include computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing exemplary embodiments. When implemented on a general-purpose microprocessor, the computer program code segments configure the microprocessor to create specific logic circuits.

While exemplary embodiments of the invention have been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed for carrying out this invention, but that the invention will include all embodiments falling within the scope of the claims.

What is claimed is:

1. A method for providing order information, the method comprising:
receiving one or more order numbers corresponding to customer orders for network provider services;
retrieving information corresponding to the order numbers from a plurality of sources, the sources including order summary data, order detail data, customer data and network data;
storing the retrieved information as consolidated order data;
receiving a request from a user for a report, the request including selection criteria specifying a subset of the consolidated order data;
creating the report by applying the selection criteria to the consolidated order data; and
transmitting the report to the user.

2. The method of claim 1 wherein the one or more order numbers are generated by extracting the order numbers from the order summary data.

3. The method of claim 1 wherein the retrieved information includes historical information about closed orders.

4. The method of claim 1 wherein the retrieved information includes information about open orders.

5. The method of claim 1 wherein the order summary data includes one or more of a department, a region, a due date, an order type, a status and a project for each of the order numbers.

6. The method of claim 1 wherein the order detail data includes one or more of a customer identifier, a rework required indicator, a due date, a date received, a date closed, a status, an order type, an order description, a department, a region, an estimated resource required, and an actual resource required for each of the order numbers.

7. The method of claim 1 wherein the customer data includes one or more of a customer name, a customer address, a geographic location, and a type of service for each of the customer identifiers.

8. The method of claim 8 wherein the network data includes one or more of a circuit detail, a network detail and an equipment type for each of the types of service at each of the geographic locations.

9. The method of claim 1 wherein the selection criteria specifies all of the consolidated order data.

10. The method of claim 1 wherein the selection criteria includes a due date range, a status, and a department and the report includes consolidated order data for order numbers assigned to the department that have due dates that fall within the due date range with the specified status.

11. The method of claim 1 wherein the selection criteria includes a status, a closed date range, and a department and the report includes consolidated order data for order numbers assigned to the department that have a closed date that falls within the date closed range with the specified status.

12. The method of claim 1 wherein the selection criteria includes a received date range, a status, and a department and the report includes consolidated order data for order numbers assigned to the department that have received dates that fall within the received date range with the specified status.

13. A system for providing order information, the system comprising:
a processor; and
software instructions executing on the processor for facilitating:
receiving one or more order numbers corresponding to customer orders for network provider services;
retrieving information corresponding to the order numbers from a plurality of sources, the sources including order summary data, order detail data, customer data and network data;
storing the retrieved information as consolidated order data;
receiving a request from a user for a report, the request including selection criteria specifying a subset of the consolidated order data;
creating the report by applying the selection criteria to the consolidated order data; and
transmitting the report to the user via a network.

14. The system of claim 13 wherein the retrieving is via the network.

15. They system of claim 13 wherein the consolidated order data is stored as one or more of a database and a spreadsheet on a storage device.

16. The system of claim 13 wherein the report is transmitted in a spreadsheet format.

17. A computer program product for providing order information, the computer program product comprising a storage medium readable by a processing circuit and storing instructions for execution by the processing circuit for facilitating a method comprising:
receiving one or more order numbers corresponding to customer orders for network provider services;
retrieving information corresponding to the order numbers from a plurality of sources, the sources including order summary data, order detail data, customer data and network data;
storing the retrieved information as consolidated order data;
receiving a request from a user for a report, the request including selection criteria specifying a subset of the consolidated order data;
creating the report by applying the selection criteria to the consolidated order data; and
transmitting the report to the user.

18. The computer program product of claim 17 wherein the retrieved information includes wherein the retrieved information includes information about closed orders and information about open orders.
